(19) United States
(12) Patent Application Publication
(10) Pub. No.: US 2005/0282723 A1
(43) Pub. Date: Dec. 22, 2005

(54) Liquid bleaching composition

(75) Inventors: Olaf Cornelis Beers, Vlaardingen (NL); Cornellis Willem Brusse, Vlaardingen (NL); Michel Gilbert Delroisse, Bebington (GB); Manoe Van Schadewijk, Vlaardingen (NL); John Leslie Storey, Bebington (GB); Simon Marinus Veerman, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/154,451

(22) Filed: Jun. 16, 2005

(30) Foreign Application Priority Data
Jun. 18, 2004 (EP) 04253656.5

(51) Int. Cl. C11D 3/00

(52) U.S. Cl. 510/376

(57) ABSTRACT

The present invention provides an aqueous liquid bleaching composition having a pH-value of less than or equal to 7 and comprising surfactant material, a bleach catalyst and an antifoam system containing fatty acid having an iodine value lower than 1.0 and a neutralising agent selected from the group consisting of a substituted amine with a C1 or C2 substitution and tetraalkyl ammoniumhydroxide having a C1-C4 alkyl group.

### FIELD OF THE INVENTION

The present invention relates to a novel liquid bleaching composition and a method for treating a textile, especially laundry fabrics, using the same. More in particular, the invention relates to a liquid bleaching composition having favourable cleaning, bleaching and foaming characteristics.

### BACKGROUND OF THE INVENTION

The use of bleaching catalysts for stain removal has been developed over recent years. The recent discovery that some catalysts are capable of bleaching effectively in the absence of an added peroxyl source has recently become the focus of some interest, as will be clear from e.g. WO-99/65905, WO-00/12667, WO-00/12808, WO-00/29537, and WO-00/60045.

The shelf life of a product may be regarded as the period of time over which the product may be stored whilst retaining its required quality. A satisfactory shelf life is in many instances a crucial factor for the success of a commercial product. A product with a short shelf life generally dictates that the product is made in small batches and is rapidly sold to the customer. It is also a concern to the owners of a brand with a short shelf life that the consumer uses the product within the shelf life; otherwise the consumer may be inclined to change to a similar product of another brand. In contrast, a similar product with a long shelf life may be made in larger batches, held as stock for a longer period of time and the period of time that a consumer stores the product is not of a great concern to the owners of the particular brand concerned. Despite the shelf life being an important consideration, the product must also be active during use.

It is an object of the present invention to provide a liquid bleaching composition that has favourable storage properties whilst being active in use.

It is another object of the invention to provide a liquid bleaching composition that shows good bleaching and cleaning performance, and additionally has moderate foaming characteristics when in use.

It is a further object of the invention to provide a liquid bleaching composition that is chemically and physically stable when in storage.

We have now surprisingly found that one or more of these objects can be achieved when using an aqueous liquid bleaching composition according to the present invention.

### SUMMARY OF THE INVENTION

Accordingly, in one aspect the present invention provides an aqueous liquid bleaching composition having a pH-value of less than or equal to 7, and comprising surfactant material, a bleach catalyst and an antifoam system containing fatty acid having an iodine value lower than 1.0 and a neutralising agent selected from the group consisting of a substituted amine with a C1 or C2 substitution and tetraalkyl ammoniumhydroxide having a C1-C4 alkyl group.

Furthermore, in a second aspect the invention provides a method of bleaching a textile, comprising the steps of:
(i) diluting from 0.5 to 20 g of a liquid bleaching composition according to the present invention with 1 litre of water;
(ii) treating the textile with the diluted composition;
(iii) rinsing the textile with water; and
(iv) drying the textile.

The iodine value according to the present invention is a measure for the level of saturation of the fatty acid: the lower the iodine value of the fatty acid, the higher is the degree of saturation. In connection with the present invention, the iodine value of a fatty acid is defined as the weight of halogens expressed as iodine absorbed by 100 parts by weight of the fatty acid. It follows that a lower iodine value will be measured if the level of saturation of the fatty acid is higher.

The iodine value is determined by the Wijs' method described by IFFO (ISO 3961:1996, May 1998) in which the test sample is dissolved in a solvent and Wijs' reagent added. After about one hour reaction time, potassium iodide and water are added to the mixture. Iodine liberated by the process is titrated with sodium thiosulphate solution.

### DETAILED DESCRIPTION OF THE INVENTION

It has been found that the aqueous liquid bleaching composition of the invention shows both good cleaning and favourable bleaching performance. In addition, it was observed that said composition has moderate foaming characteristics when in use. Furthermore, liquid bleaching compositions according to the invention were found to have favourable storage properties: their bleaching and cleaning activities were maintained after prolonged periods of storage.

Preferably, the aqueous liquid bleaching composition of the invention has a water content of 40 to 90% by weight, more preferably 45 to 80′ by weight.

Furthermore, the liquid composition of the invention is preferably isotropic and transparent. Reason is that transparent liquid detergent compositions are generally regarded to have a visually attractive appearance.

pH-Value

The pH-value of the composition of the invention is less than or equal to 7, preferably in the range of from 6 to 7, more preferably from 6.5 to 7. This range of pH-values is needed for obtaining a chemically stable composition. More in particular, it was found that the bleach catalyst can remain stable and does not dissociate when the liquid composition of the invention is stored at a pH of less than or equal to 7. Furthermore, when protease enzyme is present in the composition of the invention, said relatively low pH-value range may also be beneficial for maintaining the activity of the protease enzyme, depending on the type thereof.

However, for obtaining favourable bleaching and cleaning performance when the composition of the invention is used for treating textile, it is preferred that the pH-value of said composition is raised to the range of from 7.5 to 9 upon dilution with water. Hence, it is preferred that said composition additionally contains a pH-changing means capable of bringing about this increase of pH-value. Desirably, the pH-changing means is capable of raising the pH-value to at least 8 upon dilution with water.

The pH-changing means is effectively provided by a pH-jump system containing a boron compound, particularly borax decahydrate, and a polyol. The borate ion and certain cis 1,2-polyols complex when present in the undiluted composition, so as to cause a reduction in pH-value to a value of less than or equal to 7. Upon dilution, the complex dissociates liberating free borate to raise the pH-value in the diluted solution resulting in a pH-jump. Examples of polyols that exhibit the complexing mechanism with borax include catechol, galactitol, fructose, sorbitol, and pinacol. For economic reasons, sorbitol is the preferred polyol.

The desired ratio of the polyol to the boron compound needs to be considered since it influences performance.

To achieve the desired pH-value during storage of less than or equal to 7, ratios greater than 1:1 are preferred. The level of the boron compound, particularly borax, incorporated in the composition of the invention also influences the performance. Borax levels of at least 1% by weight are desired to ensure sufficient buffering. Excessive amounts of borax (>10% by weight) give good buffering properties; however, such levels lead to a pH-value of the undiluted composition that is higher than desired. Generally, pH-jump systems in which the weight ratio of the polyol and boron compound ranges from 1:1 to 10:1 are preferred for use in the present invention.

When applying a borax-sorbitol pH-jump system, said system preferably comprises at least 2% by weight of Sorbitol and at least 1% by weight of borax.

In practice, compositions containing, as a pH-jump system, a combination of 5% wt borax and 20% wt sorbitol were found to yield the best results.

Such a pH-jump system is known from EP-A-381,262.

Salts of calcium and magnesium have been found to enhance the pH-jump effect by further lowering the pH of the undiluted composition. Other di- and trivalent cations may be used but Ca and Mg are preferred. Any anion may be used providing the resulting Ca/Mg salt is sufficiently soluble. Chloride, although it could be used, is not preferred because of oxidation problems.

Other types of pH-jump systems are based on the principle of insoluble alkaline salts in the undiluted composition that dissolve on dilution to raise the solution pH. Examples of such alkaline salts are sodium tripolyphosphate (STP), sodium carbonate, sodium bicarbonate, sodium silicate, sodium pyro- and ortho-phosphate.

An alternative type of pH-jump system for use in a liquid detergent composition includes a metal cation and an N-containing compound, as disclosed in U.S. Pat. No. 5,484,555.

The Antifoam

The antifoam system of the present invention contains one or more fatty acids having an iodine value of lower than 1.0, preferably lower than 0.3, and a neutralising agent therefor, as further specified below.

As mentioned above, the iodine value is a measure for the level of saturation of the fatty acid; the lower the iodine value of the fatty acid, the higher is the degree of saturation.

Preferably, the fatty acid has a degree of saturation of more than 95%, said degree of saturation being most preferably 100%. Reason is that such saturated fatty acids have been found to perform favourably for reducing and controlling foaming characteristics, and to also lead to improved chemical stability of the bleach catalyst present in the composition of the invention.

Good anti-foaming results were obtained when the fatty acid is a mixture of lauric acid, myristic acid, palmitic acid, stearic acid, arachidic acid, and behenic acid.

Preferably, the level of the fatty acid of the invention is at most 8%, more preferably at most 4% by weight, most preferably at most 2% by weight based on the full liquid composition of the invention.

For obtaining favourable solubility of the saturated fatty acid in the liquid composition of the present invention, a neutralising agent selected from the group consisting of a substituted amine with a C₁ or C₂ substitution and a tetraalkyl ammonium hydroxide having a C₁-C₄ alkyl group is present in said composition.

For ensuring that the composition has both good physical stability (as a result of the favourable solubility of the fatty acid) and good pH-jump characteristics when a pH-jump system is present, the neutralising agent is preferably a substituted amine selected from the group consisting of triethanol amine, triethyl amine and dimethyl ethanolamine.

The Bleach Catalyst

The bleach catalyst per se may be selected from a wide range of transition metal complexes of organic molecules (ligands). In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes. A mixture of different catalysts may be employed in the bleaching composition.

Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98/39098; WO-A-98/39406, WO 9748787, WO 0029537; WO 0052124, and WO0060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane).

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

An example of a preferred catalyst is a monomer ligand or transition metal catalyst thereof of a ligand having the formula (I): 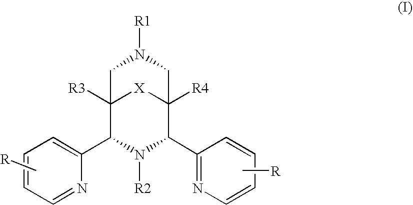
wherein each R is independently selected from: hydrogen, F, Cl, Br, hydroxyl, C1-C4-alkylO—, —NH—CO—H, —NH—CO—C1-C4-alkyl, —NH2, —NH—C1-C4-alkyl, and C1-C4-alkyl;
R1 and R2 are independently selected from:
C1-C4-alkyl,
C6-C10-aryl, and,
a group containing a heteroatom capable of coordinating to a transition metal, wherein at least one of R1 and R2 is the group containing the heteroatom;
R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)ₙC(O)OR5 wherein R5 is independently selected from: hydrogen, C1-C4-alkyl, n is from 0 to 4, and mixtures thereof; and, X is selected from C═O, —[C(R6)₂]_{y}— wherein Y is from 0 to 3 each R6 is independently selected from hydrogen, hydroxyl, C1-C4-alkoxy and C1-C4-alkyl.

With regard to the above formula (I) it is also particularly preferred that R1 and R2 may also be independently selected from: C1 to C22-optionally substituted alkyl, and an optionally substituted tertiary amine of the form —C2-C4-alkyl-NR7R8, in which R7 and R8 are independently selected from the group consisting of straight chain, branched or cyclo C1-C12 alkyl, benzyl, the —C2-C4-alkyl- of the —C2-C4-alkyl-NR7R8 may be substituted by 1 to 4 C1-C2-alkyl, or may form part of a C3 to C6 alkyl ring, and in which R7 and R8 may together form a saturated ring containing one or more other heteroatoms.

Another preferred class of ligands are macropolycyclic rigid ligands of the formula: 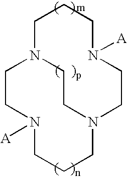
wherein m and n are 0 or integers from 1 to 2, p is an integer from 1 to 6, preferably m and n are both 0 or both 1 (preferably both 1), or m is 0 and n is at least 1; and p is 1; and A is a nonhydrogen moiety preferably having no aromatic content; more particularly each A can vary independently and is preferably selected from methyl, ethyl, propyl, isopropyl, butyl, isobutyl, tert-butyl, C5-C20 alkyl, and one, but not both, of the A moieties is benzyl, and combinations thereof.

Preferably, the macropolycyclic ligand is of the formula: 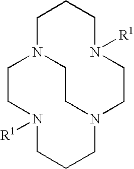
wherein “R¹” is independently selected from H, and linear or branched, substituted or unsubstituted C1-C20 alkyl, alkylaryl, alkenyl or alkynyl; and all nitrogen atoms in the macropolycyclic rings are coordinated with the transition metal.

Of the macropolycyclic ligands 5,12-dimethyl-1,5,8,12-tetraaza-bicyclo[6.6.2]hexadecane is preferred. This ligand is most preferred as its manganese complex [Mn(Bcyclam)Cl₂] and may be synthesised according to WO9839098.

The transition metal complex preferably is of the general formula (AI):
[MₐLₖXₙ]Yₘ
in which:
M represents a metal selected from Mn(II)-(III)-(IV)-(V), Cu(I)-(II)-(III), Fe (II)-(III)-(IV)-(V), Co(I)-(II)-(III), Ti (II)-(III)-(IV), V(II)-(III)-(IV)-(V), Mo (II)-(III)-(IV)-(V)-(VI) and W(IV)-(V)-(VI), preferably from Fe(II)-(III)-(IV)-(V);
L represents the ligand, preferably N,N-bis(pyridin-2-yl-methyl)-1,1-bis(pyridin-2-yl)-1-aminoethane, or its protonated or deprotonated analogue;
X represents a coordinating species selected from any mono, bi or tri charged anions and any neutral molecules able to coordinate the metal in a mono, bi or tridentate manner;
Y represents any non-coordinated counter ion;
a represents an integer from 1 to 10;
k represents an integer from 1 to 10;
n represents zero or an integer from 1 to 10;
m represents zero or an integer from 1 to 20.
   Surfactant Material

The liquid bleaching composition of the invention also contains surfactant material, preferably at a concentration of 0.1 to 50% by weight, based on the total composition.

This surfactant system may in turn comprise 0-95% by weight of one or more anionic surfactants and 5 to 100% by weight of one or more nonionic surfactants. The surfactant system may additionally contain amphoteric or zwitterionic detergent compounds. The liquid bleaching composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Also applicable are surfactants such as those described in EP-A-328 177 (Unilever), which show resistance to salting-out, the alkyl polyglycoside surfactants described in EP-A-070 074, and alkyl monoglycosides.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates, sodium C₁₂-C₁₈ alkyl sulphates and sodium linear alcohol ethoxy sulphates.

Preferred surfactant systems are mixtures of anionic with nonionic detergent active materials, in particular the groups and examples of anionic and nonionic surfactants pointed out in EP-A-346 995 (Unilever). Especially preferred is a surfactant system that is a mixture of a sodium C₁₁-C₁₅ alkyl benzene sulphonate, a C₁₂-C₁₅ primary alcohol 3-9 EO ethoxylate and a sodium linear alcohol ethoxy sulphate.

The nonionic detergent is preferably present in amounts greater than 10%, e.g. 25-90% by weight of the surfactant system. Anionic surfactants can be present for example in amounts in the range from about 5% to about 40% by weight of the surfactant system.

Other Components

The liquid bleaching composition of the invention may additionally comprise builders, solvents, enzymes, perfumes, sequestrants, polymers, fluorescers and dyes.

The use and amount of these components are such that the bleaching and cleaning performance of the composition is favourable depending on economic and environmental factors.

One skilled in the art will appreciate that some adventitious peroxyl species may be in the composition nevertheless it is most preferred that the bleaching composition of the present invention has less that 1%, preferably less than 0.1%, most preferably less than 0.01%, of a peroxyl species present. These adventitious peroxyl are predominantly alkyl hydroperoxides formed by autoxidation of the surfactants.

The composition may additionally contain enzymes as found in WO 01/00768 A1 page 15, line 25 to page 19, line 29, the contents of which are herein incorporated by reference.

Builders, polymers and other enzymes as optional ingredients may also be present, as found in WO-00/60045.

Suitable detergency builders as optional ingredients may also be present, as found in WO-00/34427.

In the context of the present invention, bleaching should be understood as relating generally to the de-colourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

The present invention extends to both isotropic and complex liquid compositions, a brief discussion of which follows. Isotropic liquid compositions are clearly preferred Some isotropic formulations are termed ‘micro-emulsion’ liquids that are clear and thermodynamically stable over a specified temperature range. The ‘micro-emulsion’ formulation may be water in oil, or oil in water emulsions. Some liquid formulations are macro-emulsions that are not clear and isotropic. Emulsions are considered meta-stable. Liquid formulations of the present invention may also contain for example; monoethoxy quats; AQAs and bis-AQAs; cationic amides; cationic esters; amino/diamino quats; glucamide; amine oxides; ethoxylated polyethyleneimines; enhancement polymers of the form linear amine based polymers, e.g. bis-hexamethylenetriamine; polyamines e.g. TETA, TEPA or PEI polymers.

The liquid may be contained within a sachet as found in WO-02/068577. The sachet is a container within the context of the present invention.

The liquid composition preferably also contains one or more antioxidants as described in WO-02/072747 and WO-02/072746.

The invention will now be illustrated by way of the following non-limiting examples, in which all parts and percentages are by weight unless otherwise indicated.

### EXAMPLES 1, A

The following liquid detergent formulations were prepared:

Example

| | 1 | A |
|---|---|---|
| Ingredient | % (wt) | % (wt) |
| LAS acid | 6.0 | 6.0 |
| SLES 3 EO | 6.0 | 6.0 |
| NI 7EO | 6.0 | 6.0 |
| Proxel GXL | 0.016 | 0.016 |
| Sorbitol | 3.3 | 3.3 |
| Borax.10H₂O | 2.3 | 2.3 |
| MPG | 4.7 | 4.7 |
| Neutralising agent | 0.75 | 0.75 |
| Prifac 5908 | 1.0/5.0 | — |
| Prifac 7908 | — | 1.0/5.0 |
| Protease enzyme | 0.4 | 0.4 |
| Bleach catalyst | 0.03 | 0.03 |

| | |
|---|---|
| Water | balance to 100 |

Wherein:
LAS acid = C10-C14 alkyl benzene sulphonic acid;
SLES = sodium lauryl ether sulphate (with on average 3 ethylene oxide groups);
NI 7EO = C12-C13 fatty alcohol ethoxylated with an average of 7 ethylene oxide groups;
MPG = monopropylene glycol;
Prifac 5908 = palmkernel fatty acid having an iodine value lower than 1.0;
Prifac 7908 = palmkernel fatty acid having an iodine value higher than 1.0;
Proxel GXL = biocide (20% active).

As a bleach catalyst, the following chemical compound was used in the examples: 9.9-dihydroxy-2,4-di-(2-pyridyl)-3-methyl-7-(pyridin-2-ylmethyl)-3,7-diaza-bicyclo[3.3.1]nonane-1,5-dicarboxylate Iron(II) dichloride. This bleach catalyst was prepared as described in Heidi Borzel, Peter Comba, Karl S. Hagen, Yaroslaw D. Lampeka, Achim Lienke, Gerald Linti, Michael Merz, Hans Pritzkow, Lyudmyla V. Tsymbal in Inorganica Chimica Acta 337 (2002), 407-419. WO-02/48301 provides synthetic details of similar compounds.

As a neutralising agent, triethanolamine (TEA) was used. The level of the neutralising agent in the liquid formulations of examples 1 and A was sufficient to bring the pH to 7. The method of preparation of these formulations was as follows: first all ingredients except the borax-sorbitol complex were mixed so as to bring the pH-value at 7, and subsequently said complex was added to the thus-formed mixture.

It can be derived from the above that the formulations of example 1 are according to the present invention and that the formulations of (comparative) example A are outside the scope of the invention.

Samples of all of these liquid formulations were stored in glass vials for two weeks at a pH of 7 and a temperature of 37° C.

Method of Determining the Bleach Catalyst Activity

The residual bleaching activity of all above liquid formulations were determined at 40° C. in a H₂O₂-containing NaH₂PO₄.H₂O pH 7 buffer and Acid Blue 45 (CAS No. 2861-O₂-1) as substrate, using the following protocol.

Samples of 70 mg liquid were diluted in 10.00 ml MilliQ water. We added 45 μl of this solution to an assay of 230 μL containing 20 mM H₂O₂, 75 μM Acid blue 45 and 54 mM NaH₂PO₄.H₂O pH 7 buffer.

The changes in absorbance at 600 nm were measured for 5 min. at 40° C. using a spectrophotometer. The absolute changes in absorbance were correlated to activities obtained with freshly prepared calibration samples. The measured activities expressed as μMol/l are shown in Table 1.

TABLE 1
The residual bleaching activity (expressed in μMol/l),
as function of fatty acid type and level in the tested liquid
formulation after storage thereof for 2 weeks at 37° C. and a pH of 7.

| Fatty acid type | 1% in formulation | 5% in formulation |
|---|---|---|
| Prifac 5908 | 2.07 | 1.43 |
| Prifac 7908 | 1.40 | 0.23 |

The results in Table 1 clearly show a bleach activity advantage in using a type of fatty acid according to the present invention (prifac 5908). This effect is significant at both levels tested but it is most pronounced at a fatty acid level of 5% by weight.

### EXAMPLE 2

In this example, various liquid detergent formulations having generally the same composition as the formulation of example 1 but differing with regard to the type of neutralising agent, were used. In these compositions, the following compounds were used as neutralising agent: triethanolamine (TEA), monoethanolamine (MEA), triethylamine, dimethyl ethanolamine, tetramethyl ammoniumhydroxide, tetraethyl ammoniumhydroxide, andtetrabutyl ammoniumhydroxide.

In these compositions, the level of the neutralising agent was sufficient to bring the pH to around 7.

Samples of these liquid formulations were stored in glass vial for two weeks at a pH of 7 and a temperature of 5° C.

During this storage period the physical stability was regularly visually inspected. It was particularly tested if precipitation and/or phase separation could be observed. At the end of the storage period, the pH-values of the formulations were measured. Subsequently, the formulations were diluted with water to obtain 0.7% wt solutions. The pH-values of the thus-formed solutions in water was also measured.

The results of all these measurements are shown in Table 2.

TABLE 2
pH-values and physical stability's as a function of the
type of neutralising agent in the tested liquid composition.

| | pH-value | pH-value | |
|---|---|---|---|
| Neutralising | before | of 0.7% | Physical |
| Agent | Dilution | solution | Stability |
| TEA | 6.7 | 7.7 | yes |
| MEA | 6.7 | 8.4 | 1 week |
| Triethylamine | 6.9 | 8.3 | yes |
| Dimethyl | 6.9 | 8.5 | yes |
| Ethanolamine | | | |
| Tetramethyl | 6.7 | 8.2 | 1 week |
| ammonium | | | |
| hydroxide | | | |
| Tetraethyl | 6.7 | 8.1 | 1 week |
| ammonium | | | |
| hydroxide | | | |
| Tetrabutyl | 6.9 | 8.2 | 1 week |
| Ammonium | | | |
| Hydroxide | | | |

It can be noticed that the physical stability of the MEA and ammoniumhydroxide containing formulations is such that phase separation was observed after 1 week of storage at 5° C. The formulations containing the other types of neutralising agent were all found to be fully stable during/after storage.

It can also be seen that the action of the pH-jump system present in the tested formulations upon dilution with water was somewhat hampered when using TEA as neutralising agent as compared to the formulations with the other types of neutralising agents. When applying TEA the pH-value was raised to 7.7 upon dilution, whereas the pH-value increased to levels above 8 with the other types of neutralising agent.

1. An aqueous liquid bleaching composition having a pH-value of less than or equal to 7 and comprising surfactant material, a bleach catalyst and an antifoam system containing fatty acid having an iodine value lower than 1.0 and a neutralising agent selected from the group consisting of a substituted amine with a C, or C₂ substitution and tetraalkyl ammoniumhydroxide having a C₁-C₄ alkyl group.

2. A liquid bleaching composition according to claim 1, wherein the neutralising agent is a substituted amine selected from the group consisting of triethanol amine, triethylamine and dimethyl ethanolamine.

3. A liquid bleaching composition according to claim 1, wherein the fatty acid has an iodine value lower than 0.3.

4. Liquid bleaching composition according to claim 1, wherein the fatty acid is a mixture of lauric acid, myristic acid, palmitic acid, stearic acid, arachidic acid and behenic acid.

5. Liquid bleaching composition according to claim 1, wherein said composition has a pH-value in the range of from 6 to 7, preferably from 6.5 to 7.

6. Liquid bleaching composition according to claim 1, wherein the bleach catalyst is an organic substance which forms a complex with a transition metal for bleaching a substrate with atmospheric oxygen, the liquid bleaching composition upon addition to an aqueous medium providing a diluted bleaching medium substantially devoid of a peroxygen bleach or a peroxy-based or peroxyl-generating bleach system.

7. Liquid bleaching composition according to claim 1, wherein the composition further contains a pH-changing means capable of raising the pH-value of said composition to the range of from 7.5 to 9.0 upon dilution of said composition with water.

8. Liquid bleaching composition according to claim 7, wherein the pH-changing means is capable of raising the pH-value to at least 8 upon dilution with water.

9. Liquid bleaching composition according to claim 7, wherein the pH-changing means is provided by a borax-sorbitol pH-jump system.

10. Liquid bleaching composition according to claim 7, wherein said pH-jump system comprises at least 2% by weight of sorbitol and at least 1% by weight of borax.

11. Liquid bleaching composition according to claim 1, wherein the water content of said composition is in the range of from 40 to 80% by weight.

12. A method of bleaching a textile, comprising the steps of:
(i) diluting from 0.5 to 20 g of a liquid bleaching composition according to claim 1 with 1 litre of water;
(ii) treating the textile with the diluted composition;
(iii) rinsing the textile with water; and
(iv) drying the textile.
